(19) United States
(12) Patent Application Publication
(10) Pub. No.: US 2012/0071587 A1
(43) Pub. Date: Mar. 22, 2012

(54) USE OF CURABLE RESINS CONTAINING A PREPOLYMER BASED ON GLYCIDYL (METH)ACRYLATE FOR MAKING MATERIALS FOR USE IN SPACE

(75) Inventors: Brigitte Defoort, Saint Madeard En Jalles (FR); Xavier Coqueret, Reims (FR); Marion Mille, Reims (FR)

(73) Assignees: ASTRIUM SAS, Paris (FR); CENTRE NATIONAL DE LA RECHERCHE SCIENTIFIQUE, Paris (FR); UNIVERSITE DE REIMS, Reims Cedex (FR)

(21) Appl. No.: 13/257,283

(22) PCT Filed: Mar. 15, 2010
(86) PCT No.: PCT/EP10/53291

§ 371 Date: Dec. 6, 2011

(30) Foreign Application Priority Data
Mar. 16, 2009 (FR) 09 51647

(51) Int. Cl. C08L 33/14; C08F 20/32; C08K 7/14; C08K 7/10; C08L 77/10; C08L 79/06; C08L 67/00; C08L 23/06; B05D 3/02; C08K 7/06

(52) U.S. Cl. 523/467; 427/386; 526/214; 526/273; 523/400; 523/468; 525/182; 525/186; 525/190; 525/208

(57) ABSTRACT

It relates to the use of curable resins containing a prepolymer based on glycidyl (meth)acrylate for making composite materials for use in space and, more particularly to composite materials entering the composition of structures intended to be deployed in space and to be stiffened after deployment.

### TECHNICAL FIELD

The present invention relates to the use of curable resins containing a prepolymer based on glycidyl (meth)acrylate for making composite materials for use in space.

It also relates to particular prepolymers based on glycidyl (meth)acrylate which are able to enter the composition of these curable resins.

It further relates to structures which are designed in order to become rigid in space, typically after having been deployed therein, and which comprise composite materials prepared from said curable resins.

Such structures are notably Gossamer structures and trellis structures of the type of those described in French patent application published under the number 2 887 523 [1].

### STATE OF THE PRIOR ART

The limited space under the caps of space launchers has led to the design of lightweight structures, which are launched folded and which deploy once they have reached space, which is i.a. the case of Gossamer structures.

These structures, which may notably consist in solar panels, reflectors, sun-screens, antennas, mirrors, solar sails or the like, comprise an assembly of hollow, generally tubular elements, which consist of fine membranes, folded on themselves so as to form bellows and the deployment of which in space results from their filling with a pressurized gas which is stored in an adjoining tank.

Once they are deployed in space, the Gossamer structures need to be stiffened so as to be able to withstand possible impacts with meteorites.

This is why the making of membranes of Gossamer structures in composite materials which consist of a fibrous material, for example a fabric of carbon fibers or of Kevlar® which is impregnated with a composition based on a curable resin of the epoxy resin type, was suggested as well as inducing the curing of this resin after deployment of said structures in space, for example by increasing the temperature or by applying ultraviolet radiations, which curing causes stiffening of the composite materials.

It is well known that in the space vacuum, materials either degas because their surface has been contaminated or because they contain or generate volatile compounds by degradation.

Now, these degassings have harmful consequences.

Indeed, if the volatile compounds are constituents of the material which degasses, or result from the degradation of constituents of this material, then the latter may lose its properties at the same time as its constituents. Further, degassing generally represents pollution of the medium. Thus, for example, it may lead in the case of a space probe to the formation of deposits on the optical instruments which may in turn lead to the loss of functionality of these instruments.

As regards degassing in space of curable resins entering the composition of the membranes of Gossamer structures, there is exceedingly few data in the literature.

In fact, the existing data are limited to an article under the names of Cadogan and Scaborough, which was published in 2001 by the American Institute of Aeronautics and Astronautics (AIAA Gossamer Spacecraft Forum, Apr. 16-19, 2001, Seattle, Wash., [2]) and in which these authors minimize the significance of this degassing and thus of its consequences. Indeed, Cadogan and Scaborough consider that degassing would be extremely limited because the layers of fibrous material impregnated with curable resin are sandwiched between two gas-proof films.

In reality, it turns out that the polymeric films, the use of which is recommended for making the walls of Gossamer structures are not actually gas-proof. Further, experience shows that it is even desirable that the walls of Gossamer structures be at least partly permeable to gases (as described in the PCT International Application published under No. WO 2006/024805, [3]) in order to avoid maintaining air pockets between the layers of fibrous material, these air pockets may actually cause deformation of the structures and perturb their deployment in space.

The problem of the harmful consequences of degassing in space of curing resins present in Gossamer structures is therefore actually a real problem. This problem is also posed and under the same terms, for all the other structures intended to be deployed and stiffened in space and in which provision is made for using a fibrous material impregnated with a composition based on a curable resin like the cord structures described in the aforementioned reference [1].

A certain number of patent documents deal with the degassing of curable resins.

However, it should be noted that not only these documents aim at applications (adhesives, packages, protection against fire, photoglyptography for microprocessors, micro-electronics, . . . ) which have nothing to do with the space field, but that additionally, their goal is to avoid degassing after polymerization of the resins or during depolymerization of these resins while, in the case of Gossamer structures and other lightweight structures for deployment and stiffening in space, it is especially degassing which occurs before polymerization of the resins and during the polymerization of these resins, which is a problem.

The inventors therefore set a goal of providing curable resins which do not degas very much when they are subject to temperature and pressure conditions similar to those prevailing in a space environment so that the use of these resins may lead to composite materials meeting the ECSS-Q-70-02A standard of the European Space Agency, relating to the degassing of materials for use in space.

They also set the goal that these curable resins before curing have a viscosity such that it is possible to use them for impregnating fibrous materials and that the thereby impregnated materials, when they are folded on themselves like in a Gossamer structure, retain flexibility as long as this structure is not led to becoming stiff in space.

### DISCUSSION OF THE INVENTION

These objects and further other ones are achieved by the present invention which relates to the use of a curable resin containing a prepolymer which comprises at least one recurrent unit of formula (1) hereafter:

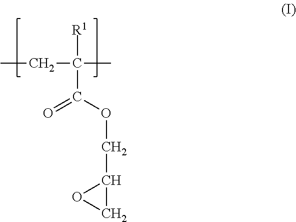

wherein R¹ represents a hydrogen atom or a methyl group, for making a composite material which is intended to be stiffened in space, i.e. in the space vacuum, by curing of the curable resin which it contains.

Thus, according to the invention, a resin is used, which contains a prepolymer comprising at least one recurrent unit which results from the polymerization of glycidyl methacrylate or acrylate and which therefore includes an epoxy function.

In the foregoing and in the following, by “curable resin containing a prepolymer” is meant a curable resin which may both be a resin exclusively consisting of this prepolymer (like the resin described in Example 1) and a resin comprising this prepolymer in a mixture with other constituents such as a formulated resin, containing one or more additives of the types: latent cross-linking initiator, cross-linking accelerator or inhibitor, anti-oxidant, compatibilizing agent, fillers, reactive or non-reactive diluent etc.

According to the invention, the molar percentage of the recurrent unit of formula (1) in the prepolymer is advantageously from 20 to 100%, which means that this recurrent unit represents, as a number of moles, at least 20% of the total number of moles making up the prepolymer and may account for up to 100% of the latter.

According to a preferred arrangement of the invention, the prepolymer comprises:
at least one first recurrent unit of the formula (I) hereinbefore; and
at least one second recurrent unit of the formula (II) hereafter:

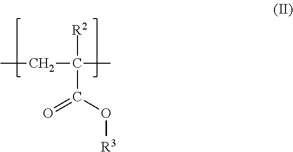

wherein R² represents a hydrogen atom or a methyl group and R³ represents an alkyl group with a linear or branched chain and having from 1 to 10 carbon atoms.

In this case, the prepolymer comprises at least two recurrent units, one of which results from the polymerization of glycidyl methacrylate or acrylate, while the other one results from the polymerization of a methacrylate or acrylate of a linear or branched C₁-C₁₀ alkyl such as, for example methyl, ethyl, propyl (n-Pr or i-Pr), butyl (n-Bu, i-Bu, s-Bu or t-Bu), ethylhexyl or further decyl methacrylate or acrylate.

According to the invention, the first recurrent unit preferably results from the polymerization of glycidyl methacrylate and therefore fits the particular formula (Ia) hereafter:

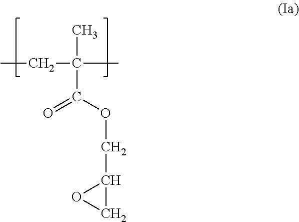

while the second recurrent unit itself results preferably from the polymerization of n-butyl acrylate and therefore fits the particular formula (IIa) hereafter:

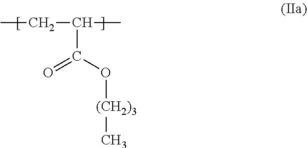

According to a more preferred arrangement of the invention, the prepolymer is a copolymer, i.e. it only comprises two recurrent units, one of formula (I) and the other of formula (II), in which case it is preferably a poly(glycidyl methacrylate-co-n-butyl acrylate).

However, this prepolymer may quite comprise one or more additional recurrent units of the (meth)acrylate type or not, either bearing epoxy groups or not, like:
a unit resulting from polymerization of a silyl (meth)acrylate of the formula (III) hereafter:

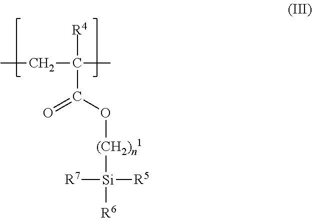

wherein R⁴ represents a hydrogen atom or a methyl group, n¹ represents an integer ranging from 1 to 10, while R⁵, R⁶ and R⁷, either identical or different, represent a hydrogen atom or an alkyl group with a linear or branched chain and having from 1 to 10 carbon atoms; such a unit is for example a unit resulting from the polymerization of 3-tris(trimethylsiloxy)silyl]propyl methacrylate;
a unit resulting from the polymerization of an amino alkyl (meth)acrylate of the formula (IV) hereafter:

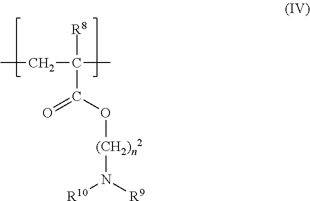

wherein R⁸ represents a hydrogen atom or a methyl group, n² represents an integer ranging from 1 to 10, while R⁹ and R¹⁰, either identical or different, represent an alkyl group with a linear or branched chain and having from 1 to 10 carbon atoms; such a unit is for example a unit resulting from the polymerization of 2-diaminoethyl methacrylate;
a unit resulting from the polymerization of a fluorinated (meth)acrylate of the formula (V) hereafter:

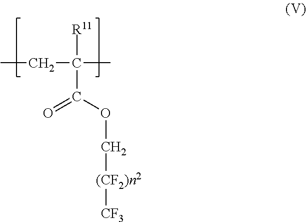

wherein R¹¹ represents a hydrogen atom or a methyl group, while n³ is an integer ranging from 0 to 10; such a unit is for example a unit resulting from the polymerization of 2,2,2-trifluoroethyl acrylate;
or further
a (meth)acrylate bearing a functional group capable of playing the role of an initiator.

Whatever the case, the molar percentage of the first recurrent unit in the prepolymer is preferably from 40 to 70% and even better from 45 to 65%, while the molar percentage of the second recurrent unit in the prepolymer itself is preferably from 30 to 60% and, even better from 35 to 55%.

According to the invention, the prepolymer is preferentially obtained by free-radical solution polymerization, in which case the polymerization is advantageously either carried out via a thermal route or even better via a photochemical route, this second route having actually been shown to be simpler to apply than the thermal route, while leading to prepolymers which have a very good compromise between the sought degassing and viscosity properties.

The polymerization via a thermal route may, for example, be achieved by a method in which:
the monomer(s) and a thermal initiator such as azobisisobutyronitrile or benzoyl peroxide, are dissolved in an organic solvent of the ethyl acetate or butyl acetate type;
the thereby obtained reaction medium is heated to a temperature ranging from 25 to 120° C., for example 75° C., for a duration from 0.5 to 48 hours, for example 24 hours, and then
the polymerization is stopped and the resulting prepolymer is isolated, for example by precipitation in a cold solvent, for example an alcoholic solvent such as methanol or a hydro-alcoholic solvent such as a methanol/water mixture, or by evaporation of the other constituents of the reaction medium (solvent, initiator and remaining monomer(s)).

As for polymerization via a photochemical route, it may itself be achieved by a method in which:
the monomer(s) and a photosensitive initiator such as 2-hydroxy-2-methyl-propan-1-one or hydroxyalkylphenone, are dissolved in an organic solvent of the ethyl acetate or butyl acetate type;
the thereby obtained reaction medium is subject to light radiation with wavelength(s) located in the photosensitivity range of the initiator, for a duration from 10 minutes to 6 hours, for example from 1 to 2 hours; and then;
the resulting prepolymer is isolated, for example by precipitation in a cold solvent, for example an alcoholic solvent such as methanol or a hydro-alcoholic solvent such as a methanol/water mixture, or by evaporation of the other constituents of the reaction medium, solvent, initiator and remaining monomer(s).

In the case when it is desired to obtain a not very viscous prepolymer, the radical polymerization is advantageously carried out in the presence of a chain transfer agent, the presence of which in the reaction medium gives the possibility of obtaining prepolymers which have a viscosity below that of prepolymers prepared according to the same operating procedure but without using any chain transfer agent.

In this case, it is preferred that this chain transfer agent be a multifunctional agent of the polythiol type and more particularly, a tetrathiol such as pentaerythritol tetrakis(2-mercaptoacetate), pentaerythritol tetrakis(thioglycolate) or pentaerythritol tetrakis(3-mercaptopropionate), the use of which leads to prepolymers which combine low viscosity with low degassing tendency.

This is very likely related to the fact that these prepolymers have a star structure, i.e. a structure consisting of a central unit of the formula (VI) hereafter:

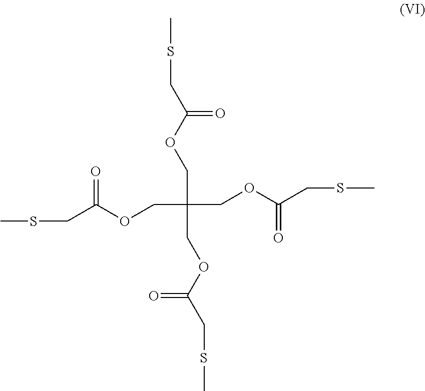

on which are grafted four linear chains formed by the recurrence of at least one recurrent unit of formula (I) and, even better by the random recurrence of at least one recurrent unit of formula (I) and of at least one recurrent unit of formula (II).

For example, in the case of a poly(glycidyl methacrylate-co-n-butyl acrylate), this gives the structure of formula (VII) hereafter:

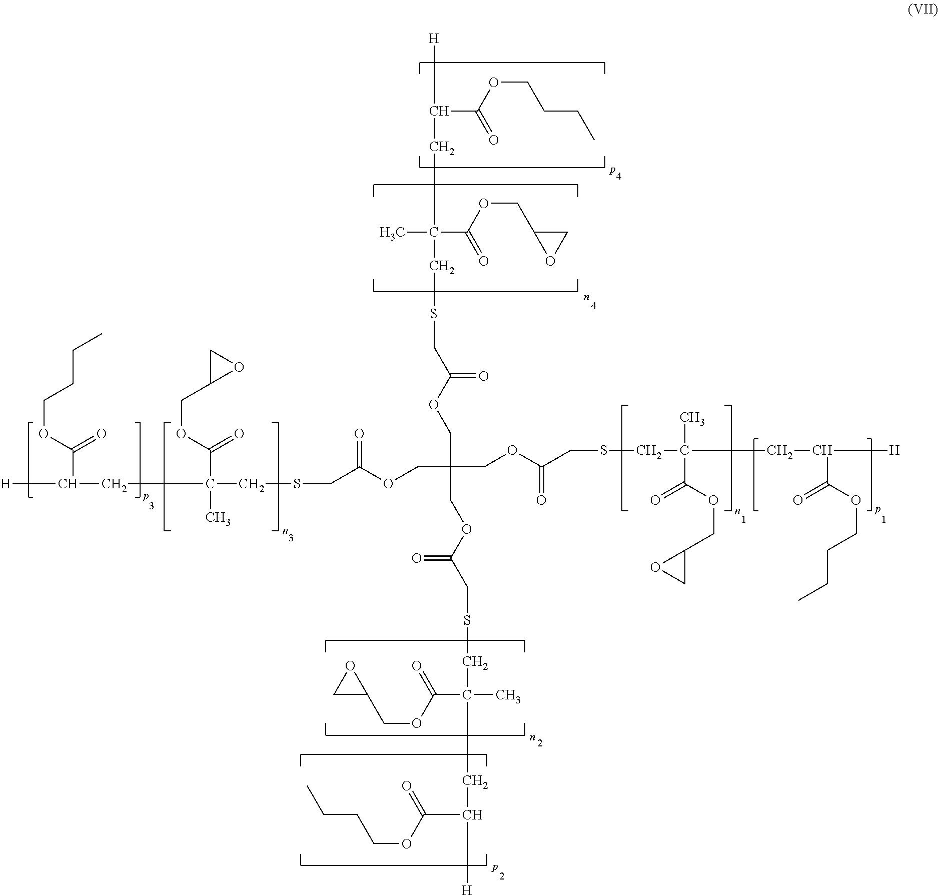

wherein n₁, n₂, n₃ and n₄, either identical or different, represent the number of times the unit of formula (Ia) is repeated (randomly), while p₁, p₂, p₃ and p₄, either identical or different, represent the number of times the recurrent unit of formula (IIa) is repeated (randomly).

According to the invention, the composite material may be obtained by impregnating a fibrous material with the curable resin or with a mixture comprising this resin and one or more additives of the types: latent cross-linking initiator, cross-linking accelerator or inhibitor, anti-oxidant, compatibilizing agent, fillers, reactive or non-reactive diluent etc. if said resin does not already contain such additives.

This impregnation may be carried out by all the techniques for making prepregs known to one skilled in the art (see, for example the textbook “TECHNIQUES DE L'INGENIEUR”, Plastiques et Composites, volume AM5). It may also be carried out by injecting said resin or said mixture into the fibrous material, for example by the technique known under the acronym of “RTM” (for “Resin Transfer Molding”).

The fibrous material may be of different types. Thus, this may be a material consisting of glass fibers, quartz fibers, carbon fibers, graphite fibers, silica fibers, metal fibers such as steel fibers, aluminium fibers or boron fibers, organic fibers such as aramide fibers, polyethylene fibers, polyester fibers or poly(p-phenylene benzobisoxazole) fibers, more known under the acronym of PBO, or further silicon carbide fibers.

It may, depending on the nature of the fibers which make it up, appear in the form of cut threads, milled fibers, mats with continuous filaments, mats with cut filaments, rovings, fabrics, knits, felts, . . . , or further in the form of complexes made by associating different types of planar materials.

According to a particularly preferred arrangement of the invention, the composite material is a composite material for a structure to be deployed and stiffened in space, and in particular for a Gossamer structure or a trellis structure of the type of those described in the aforementioned reference [1].

The object of the invention is also a prepolymer which has a structure consisting of a central unit of formula (VI) as defined earlier, on which are grafted four linear chains formed by the recurrence of at least one recurrent unit of formula (I) as defined earlier.

According to a preferred arrangement of the invention, this prepolymer comprises a structure consisting of a central unit of formula (VI), on which are grafted four linear chains formed by the random distribution of at least one recurrent unit of formula (I) and of at least one unit of formula (II) as described earlier.

Still better, in this prepolymer, the recurrent unit of formula (I) fits the particular formula (Ia) as defined earlier, while the recurrent unit of formula (II) fits the particular formula (IIa) as defined earlier.

The object of the invention is further a structure for deployment and stiffening in space, i.e. in the space vacuum, which comprises a fibrous material impregnated with a curable resin as defined earlier or with a mixture comprising this resin and one or more additives of the types: latent cross-linking initiator, cross-linking accelerator or inhibitor, anti-oxidant, compatibilizing agent, fillers, reactive or non-reactive diluent etc. if said resin does not already contain such additives.

Here also, the fibrous material is preferably selected from the group formed by glass fibers, quartz fibers, carbon fibers, graphite fibers, methyl fibers, poly(p-phenylene benzobis-oxazole) fibers, aramide fibers, polyethylene fibers, boron fibers, silicon carbide fibers, and mixtures thereof.

Other features and advantages of the invention will become apparent from the additional description which follows and which relates to examples for preparing useful resins according to the invention and to examples which have allowed validation of the use of these resins for making composite materials intended to be stiffened in the space vacuum.

Of course, this additional description is only given as an illustration of the invention and is by no means a limitation thereof.

### DISCUSSION OF PARTICULAR EMBODIMENTS

### Example 1

### Preparation and Characteristics of Useful Resins According to the Invention

Resins are prepared, each consisting of a poly(glycidyl methacrylate-co-n-butyl) prepolymer by free-radical solution polymerization, via a thermal route on the one hand and via a photochemical route on the other hand, of glycidyl methacrylate and n-butyl acrylate.

The resins obtained via a thermal route are designated as T1 to T11 hereafter while those obtained via a photochemical route are designated as P1 to P5 hereafter.

1. Polymerization via a Thermal Route:

It is carried out under an argon atmosphere, by using azobisisobutyronitrile (or AIBN, available from Sigma-Aldrich) as a thermal initiator and, for certain resins, a chain transfer agent which is either carbon tetrabromide (or CBr₄, available from Sigma-Aldrich) or pentaerythritol tetrakis(2-mercapto-acetate) (or PETMA, available from Sigma-Aldrich).

The operating procedure is the following: in a 250 mL two-neck flask, glycidyl methacrylate (or GMA, available from Sigma-Aldrich), AIBN and, if necessary, the chain transfer agent are dissolved in ethyl acetate, and butyl acetate (or BA, available from Sigma-Aldrich) is then added and the reaction medium is placed under argon bubbling for 30 minutes. The reaction medium is then placed in an oil bath at 75° C. for 24 hours with magnetic stirring. At the end of which, it is then transferred into an ampoule and then poured dropwise in a cold solvent. The precipitate is collected and then dried in vacuo in a dryer.

For all the resins, both monomers (GMA and BA) and ethyl acetate are used in proportions such that these monomers are at 20% by weight in the solvent and that the molar percentage of GMA introduced into the reaction medium (and which corresponds to the ratio between the number of moles of GMA introduced into the reaction medium and the total number of moles of monomers introduced into the reaction medium, multiplied by 100) is 43%.

On the other hand, the proportion of AIBN, the nature and the temperature of the solvent used for the precipitation as well as the nature of the transfer agent and the proportion when the latter is present, are varied.

These variations are shown in Table I hereafter.

TABLE I

| | | Transfer | |
|---|---|---|---|
| | Mass %* of | Agent | Precipitation |
| Resin | AIBN | (Mass %**) | Solvent (T) |
| T1 | 0.45% | — | MeOH |
| | | | (5° C.) |
| T2 | 1% | — | MeOH |
| | | | (5° C.) |
| T3 | 9% | — | MeOH |
| | | | (5° C.) |
| T4 | 6% | — | MeOH |
| | | | (5° C.) |
| T5 | 1% | CBr₄ | MeOH |
| | | (3.2%) | (−10° C.) |
| T6 | 1% | CBr₄ | MeOH |
| | | (2.4%) | (−10° C.) |
| T7 | 1% | CBr₄ | MeOH/H₂O 95/5 |
| | | (2.4%) | (−10° C.) |
| T8 | 1% | CBr₄ | MeOH/H₂O 90/10 |
| | | (2.4%) | (−10° C.) |
| T9 | 1% | CBr₄ | MeOH/H₂O 90/10 |
| | | (3.2%) | (−10° C.) |
| T10 | 1% | CBr₄ | MeOH/H₂O 80/20 |
| | | (2.4%) | (−10° C.) |
| T11 | 1% | PETMA | MeOH |
| | | (1%) | (5° C.) |

*mass of AIBN based on the total mass of the reaction medium;
**mass of the transfer agent based on the total mass of the reaction medium.

2. Polymerization via a Photochemical Route:

It is carried out by using 2-hydroxy-2-methyl-1-phenyl-propan-1-one (or HMPP, available from Ciba Specialty Chemicals under the commercial reference Darocur® 1173) as a photosensitive initiator and, for certain resins, a chain transfer agent which is either 1-dodecanethiol (or DDT, available from Sigma-Aldrich) or PETMA.

The operating procedure is the following: in a 250 mL two-neck flask, glycidyl methacrylate HMPP and, if necessary, the chain transfer agent are dissolved in ethyl acetate, and then butyl acrylate is added which is bubbled with argon beforehand. The reaction medium is placed in sealed glass tubes, in an amount of 9 mL of reaction medium per tube. The tubes are placed in a photochemical reactor Rayonet RPR-100 from Southern England Ultra Violet Company and irradiated at the wavelength of 350 nm. After irradiation, the solvent is evaporated by means of a rotary evaporator (Rotavap) while HMPP, the remaining monomers and if necessary the remaining chain transfer agent are evaporated with a vane pump (10⁻² mbar), at a temperature of the order of 90° C.

For all the resins, both monomers (GMA and BA) and ethyl acetate are used in proportions such that these monomers are at 5 to 50% and typically at 20% by mass in this solvent and that the molar percentage of GMA introduced into the reaction medium is 43%.

On the other hand, the proportion of HMPP, the duration of the irradiation as well as the nature and the proportion of the transfer agent when the latter is present are varied.

These variations are shown in the table II hereafter.

TABLE II

| | | | Duration of |
|---|---|---|---|
| | Mass % of | Transfer Agent | the |
| Resin | HMPP* | (Mass %**) | irradiation |
| P1 | 1% | — | 2 hours |
| P2 | 1% | — | 2 hours |
| P3 | 1% | — | 2 hours |
| P4 | 0.5% | DDT | 1 hour |
| | | (2%) | |
| P5 | 0.5% | PETMA | 1 hour |
| | | (4.28%) | |

*mass of HMPP based on a total mass of the reaction medium;
**mass of the transfer agent based on the total mass of the reaction medium.

3. Characteristics of the Obtained Resins:

The resins obtained hereinbefore were subject to analysis for determining the molar percent of GMA present in the prepolymers which make them up, their room temperature viscosity (except when the resins prove to be solid or too viscose at this temperature so that their viscosity may be measured at this temperature) their viscosity at 60° C. and their tendency to degas.

The molar percentages of GMA were determined by ¹H NMR spectrometry (Bruker 250 MHz spectrometer) in deuterated chloroform and by using tetramethylsilane as an internal standard.

The viscosities were determined by means of a rotary viscosimeter (viscosimeter AR 2000.ex from TA Instruments) allowing simultaneous measurement of the shear rate gradient and the shear stress or tension. A temperature gradient from 20 to 100° C. at a rate of 5° C./minute was applied to the resins and a shear rate gradient of 1 per second. The viscosities were calculated by means of the following equation η=τ/D wherein η is the viscosity in Pa.s, τ is the shear tension in Pa and D is the shear rate gradient in s⁻¹.

As for the tendency to degassing, it was determined by a degassing test developed by Astrium Space Transportation.

This test, which is simpler to apply than that of the ECSS-Q-70-02A standard but which is also stricter than it, in a first phase consists of conditioning the samples for which the tendency to degassing is intended to be tested by leaving them for 6 hours (t₀→t₆) at the temperature of 23° C. and in a vacuum of 2 hPa, and then submitting these samples to thermogravimetric analysis by applying to them a rise in temperature of 0.2° C. per minute until 150° C. is reached (t₆→t_{˜12}) on the one hand and a pressure of 2 Pa on the other hand.

A degassing rate is thereby determined, which corresponds to the total mass loss experienced by the samples during the thermogravimetric analysis, i.e. between t₆ and t_{˜12}, expressed as a percentage of the mass which these samples have at t₆.

The results of the different analysis are shown in table III hereafter.

TABLE III

| | | Molar | | | |
|---|---|---|---|---|---|
| | | % of | Viscosity | Viscosity | Degassing |
| | Resin | GMA | at RT | at 60° C. | Rate |
| Thermal route | T1 | 52% | solid | — | 0.44% |
| | T2 | 52% | solid | — | 0.79% |
| | T3 | 57% | solid | — | 0.72% |
| | T4 | 56% | solid | 4774 Pa · s | 0.99% |
| | T5 | 56% | too | 2435 Pa · s | 3.22% |
| | | | viscous | | |
| | T6 | 54% | too | 2153 Pa · s | 2.57% |
| | | | viscous | | |
| | T7 | 50% | too | 533 Pa · s | 3.45% |
| | | | viscous | | |
| | T8 | 48% | too | 352 Pa · s | 4.39% |
| | | | viscous | | |
| | T9 | 47% | too | 103 Pa · s | 7.5% |
| | | | viscous | | |
| | T10 | 46% | too | 92 Pa · s | 6.57% |
| | | | viscous | | |
| | T11 | 45% | 2557 Pa · s | 27.7 Pa · s | 5% |
| | | | at 20° C. | | |
| Photochemical | P1 | 51% | 3552 Pa · s | 40 Pa · s | 3.74% |
| route | | | at 25° C. | | |
| | P2 | 48% | 1630 Pa · s | 39 Pa · s | 3.94% |
| | | | at 22° C. | | |
| | P3 | 52% | 2159 Pa · s | 27 Pa · s | 5.24% |
| | | | at 25° C. | | |
| | P4 | 61% | 168 Pa · s | 4.2 Pa · s | 6.91% |
| | | | at 25° C. | | |
| | P5 | 64% | 125 Pa · s | 2 Pa · s | 4% |
| | | | at 22° C. | | |

These results show that the resins obtained via the thermal route are those which have the lowest degassing rates but are also those which have the highest viscosity.

Moreover, they show that the viscosity of a resin obtained by a given operating mode may be lowered by adding to the reaction medium a mono- or multi-functional chain transfer agent and this, both in the case when free-radical polymerization is carried out via a thermal route and in that when it is carried out via a photochemical route.

They also show that the use of a multi-functional chain transfer agent and, in particular, of a tetrathiol such as PETMA, with which prepolymers having a star structure may be obtained, leads to resins which have both very low degassing rate and very low viscosity.

Further they show that it is possible to adjust the degassing and viscosity properties of the resins according to the use for which they are intended by acting on the conditions under which they are prepared (nature and proportion of the initiator, nature of the solvent for dissolving the monomers, polymerization temperature in the case of a polymerization via a thermal route, spectrum of the light radiation and duration of the irradiation in the case of polymerization via a photochemical route, either present or not of a chain transfer agent, etc.).

In this respect, it should be noted that in the field of the making of composite materials intended to be stiffened in space, it is not systematically sought to use curable resins with very low viscosity. Thus, it is actually desirable to have resins which are very slightly viscous such as resin P5 for making cord structures of the type of those described in the aforementioned reference [1], the making of prepregs for Gossamer structures itself requires the use of resins with higher viscosity such as the resins P1 and P2 so that these prepregs have sufficient tackiness so as to adhere on themselves as well as on the films intended to protect them.

### Example 2

### Validation of the Use of Useful Resins According to the Invention for the Making of Composite Materials for Use in Space

1. Making a Trellis Structure:

The resin P5 prepared in Example 1 herein before is mixed with N-benzylpyrazinium hexafluoroantimonate which is a thermal initiator capable of inducing cross-linking and therefore the curing of the epoxy resins via a cation route under the effect of an increase in temperature. The proportions used are 4 parts of initiator for 100 parts of resin and mixing is carried out at 75° C. Once the mixture has been completed, it is left to rest 5 minutes at 75° C. so as to let the air bubbles escape.

And the cords of a structure as described in the aforementioned reference [1] are then impregnated with the thereby obtained P5 resin/initiator mixture.

These cords consist of four strands which are each formed with an assembly of poly(p-phenylene benzobisoxazole) (or PBO) fibers at the centre of which circulates a carbon fiber and which are gathered in a polytetrafluoroethylene sheath.

The impregnation of the cords by the P5 resin/initiator mixture is carried out by directly injecting this mixture, heated beforehand to 78° C., into these cords by applying a pressure of 6 bars at the injection point. The duration of the injection is from 2 to 3 hours for a 2 m long cord and the impregnation level is of 44% (v/v).

And samples of the thereby impregnated cords are then subject to a degassing test which is carried out according to the ECSS-Q-70-02A standard.

It is recalled that the degassing test of the standard consists of:
conditioning the samples of the material for which the degassing tendency is intended to be tested by leaving these samples for 24 hours (t₀→t₂₄) at a temperature of (22±3)° C. and at a relative humidity of (55±10)%;
submitting these samples to thermogravimetric analysis which is carried out for 24 hours (t₂₄→t₄₈), at a temperature of 125° C. and in a vacuum of at least 10⁻³ Pa; and then
again conditioning the samples by leaving them for 24 hours (t₄₈→t72) at a temperature of (22±3)° C. and at a relative humidity of (55±10)%.

The three following criteria are used:
the TML, which corresponds to the total mass loss exhibited by the samples during the thermogravimetric analysis, i.e. between t₂₄ and t₄₈, and which is expressed as a percentage of the mass of the samples at t₂₄;
the RML, which corresponds to the total mass loss exhibited by the samples without water reabsorption by the samples, i.e. without the mass of steam reabsorbed by the samples between t₄₈ and t₇₂, and which is expressed as a percentage of the mass of the samples at t₂₄; and
the CVCM, which corresponds to the amount of material released by the degassing of the samples during the thermogravimetric analysis and which condenses on a collector, and which is also itself expressed as a percentage of the mass of the samples at t₂₄.

A material is considered as meeting the ECSS-Q-70-02A standard when it has a TML of less than 1.0%, an RML of less than 1.0% and a CVCM of less than 0.10%.

In this case, the samples of cords impregnated with the P5 resin/initiator mixture pass this test successfully when they have on the average a TML of 0.83%, an RML of 0.65% and a CVCM of 0.05%.

2. Making a Prepreg for a Gossamer Structure:

70 g of the resin P2 prepared in Example 1 hereinbefore are mixed with 7 g of hexafluoro-phosphate of the iron-cyclopentadienyl 1-methyl-naphthalene complex which is a photochemical initiator capable of inducing cross-linking and, therefore the curing of the epoxy resins via a cation route under the effect of light radiation. This mixing is carried out at 80-85° C.

A glass taffeta E of 130 g/m² (Porcher Industries) is then impregnated with the thereby obtained P2 resin/initiator mixture. The impregnation is carried out in an oven at 70° C., by a standard technique of impregnation in vacuo. The impregnation level is 31%.

Next, samples of the thereby impregnated glass taffeta are then subject to a degassing test which is carried out according to the ECSS-Q-70-02A standard.

There again, these samples successfully pass this test since they have on the average a TML of 0.60%, an RML of 0.45% and a CVCM of 0.06%.

### CITED REFERENCES

### [1] FR-A-2 887 523

### [2] D. P. Cadogan and S. E. Scaborough, 2001, American Institute of Aeronautics and Astronautics, AIAA Gossamer Spacecraft Forum, 16-19 Avril 2001, Seattle, Wash.

[3] WO-A-2006/024805

1.-16. (canceled)

17. A prepolymer which has a structure consisting of a central unit of formula (VI) hereafter: 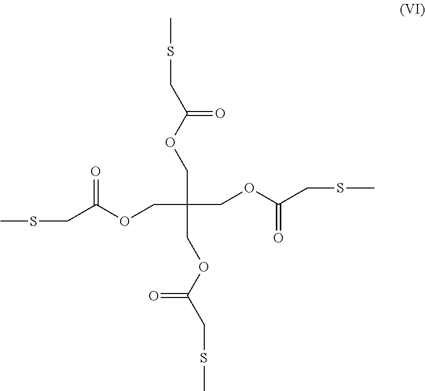
on which are grafted four linear chains formed by the recurrence of at least one recurrent unit of formula (I) hereafter: 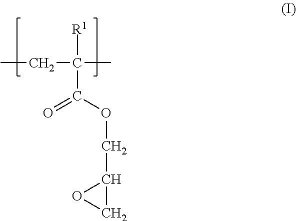
wherein R¹ represents a hydrogen atom or a methyl group.

18. The prepolymer of claim 17, which comprises a structure consisting of a central unit of formula (VI), on which are grafted four linear chains formed by the random recurrence of at least one recurrent unit of formula (I) and of at least one unit of formula (II) hereafter: 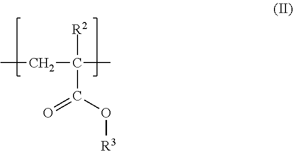
wherein R² represents a hydrogen atom or a methyl group and R³ represents an alkyl group with a linear or branched chain and having from 1 to 10 carbon atoms.

19. The prepolymer of claim 17, wherein the recurrent unit of formula (I) fits the particular formula (Ia) hereafter:

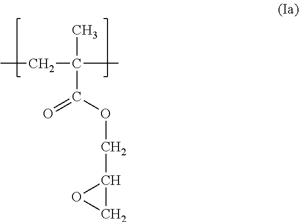

20. The prepolymer of claim 18, wherein the recurrent unit of formula (II) fits the particular formula (IIa) hereafter:

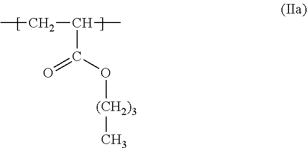

21. (canceled)

22. (canceled)

23. A method of making a composite material that stiffens in space vacuum comprising:
curing a curable resin comprising a prepolymer, said prepolymer comprising at least one recurrent unit of formula (I) hereafter: 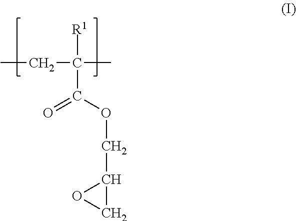
wherein R¹ represents a hydrogen atom or a methyl group.

24. The method of claim 23, wherein the molar percentage of the recurrent unit of formula (I) in the prepolymer is from 20 to 100%.

25. The method of claim 23, wherein the prepolymer comprises:
at least one recurrent unit of formula (I); and
at least one recurrent unit of formula (II) hereafter: 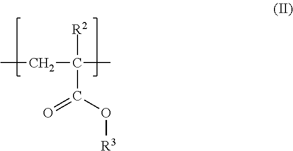
wherein R² represents a hydrogen atom or a methyl group and R³ represents an alkyl group with a linear or branched chain and having from 1 to 10 carbon atoms.

26. The method of claim 23, wherein the recurrent unit of formula (I) fits the particular formula (Ia) hereafter:

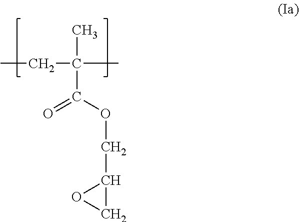

27. The method of claim 25, wherein the recurrent unit of formula (II) fits the particular formula (IIa) hereafter:

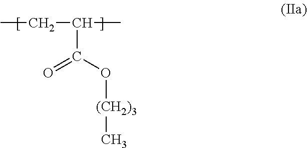

28. The method of claim 25, wherein the prepolymer is a poly(glycidyl methacrylate-co-butyl acrylate).

29. The method of claim 25, wherein the molar percentage of the recurrent unit of formula (I) in the prepolymer is from 40 to 70% while the molar percentage of the recurrent unit of formula (II) in the prepolymer is from 30 to 60%.

30. The method of claim 29, wherein the molar percentage of the recurrent unit of formula (I) in the prepolymer is from 45 to 65% while the molar percentage of the recurrent unit of formula (II) in the prepolymer is from 35 to 55%.

31. The method of claim 23, wherein the prepolymer is obtained by free-radical solution polymerization of at least one monomer formed by glycidyl (meth)acrylate.

32. The method of claim 25, wherein the prepolymer is obtained by free-radical solution polymerization of at least one first monomer formed by glycidyl (meth)acrylate and of at least one second monomer formed by a (meth)acrylate of an alkyl with a linear or branched chain and having from 1 to 10 carbon atoms.

33. The method of claim 32, wherein the free-radical polymerization is carried out via a thermal route or via a photochemical route.

34. The method of claim 23, wherein the prepolymer has a structure consisting of a central unit of formula (VI) hereafter: 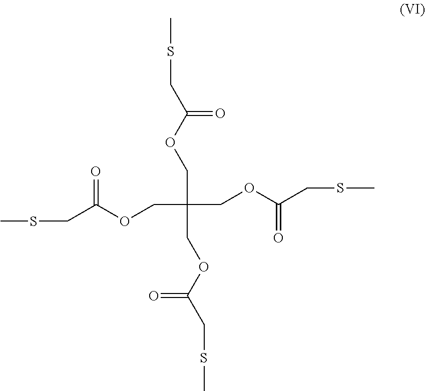
on which are grafted four linear chains formed by the recurrence of at least one recurrent unit of formula (I).

35. The method of claim 25, wherein the prepolymer has a structure consisting of a central unit of formula (VI) hereafter: 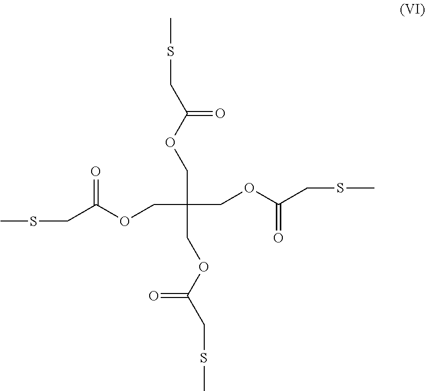
on which are grafted four linear chains formed by the random recurrence of at least one recurrent unit of formula (I) and of at least one recurrent unit of formula (II).

36. The method of claim 23, wherein the composite material is made by impregnating a fibrous material with the curable resin or with a mixture comprising the curable resin and one or more additives.

37. The method of claim 36, wherein the fibrous material is selected from the group consisting of glass fibers, quartz fibers, carbon fibers, graphite fibers, silica fibers, methyl fibers, poly(p-phenylene benzobisoxazole) fibers, aramide fibers, polyethylene fibers, polyester fibers, silicon carbide fibers and mixtures thereof.

38. The method of claim 23, wherein the composite material is a composite material for a structure to be deployed and stiffened in space.

39. A structure for deployment and stiffening in vacuum of space, which comprises a composite material comprising a fibrous material impregnated with the curable resin as defined in claims 23 or with a mixture comprising the curable resin and one or more additives.

40. The structure of claim 39, wherein the fibrous material is selected from the group consisting of glass fibers, quartz fibers, carbon fibers, graphite fibers, silica fibers, metal fibers, poly(p-phenylene benzobisoxazole) fibers, aramide fibers, polyethylene fibers, polyester fibers, silicon carbide fibers and mixtures thereof.
